(19) United States
(12) Patent Application Publication
(10) Pub. No.: US 2010/0047485 A1
(43) Pub. Date: Feb. 25, 2010

(54) POLARIZING FILM

(75) Inventors: Yasuko Iwakawa, Ibaraki-shi (JP); Tetsuo Inoue, Ibaraki-shi (JP); Shoichi Matsuda, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/521,790

(22) PCT Filed: Sep. 25, 2008
(86) PCT No.: PCT/JP2008/067316

§ 371 Date: Jun. 30, 2009

(30) Foreign Application Priority Data
Nov. 30, 2007 (JP) 2007-309610

(51) Int. Cl. C09K 19/34

(52) U.S. Cl. 428/1.31; 252/299.61

(57) ABSTRACT

A polarizing film formed by orienting organic dyes composed of a lyotropic liquid crystal compound, which comprises an acenaphtho[1,2-b]quinoxaline-base compound, wherein the content of the acenaphtho[1,2-b]quinoxaline-base compound is less than 10 weight parts with respect to 100 weight parts of the organic dyes.

### FIELD OF THE INVENTION

The present invention relates to a polarizing film formed by orienting a lyotropic liquid crystal compound.

### BACKGROUND OF THE INVENTION

In a liquid crystal display (LCD), a polarizing plate is used to control optical rotation of beams that pass through liquid crystals. Conventionally, in such a polarizing plate, a polarizer obtained by dying a resin film, such as a polyvinyl alcohol or the like with iodine or a dichromatic dye and stretching the film in one direction has been widely used. However, there has been a problem that the aforementioned polarizers are poor in heat resistance and light resistance depending on the kind of the dye or the resin film. Moreover, stretching devices have become bigger as liquid crystal displays become bigger, which has become a problem.

In contrast, a method for forming a polarizing film by coating a coating fluid containing a lyotropic liquid crystal compound on a substrate, such as a glass plate or a resin film to orient the lyotropic liquid crystal compound is known. The lyotropic liquid crystal compound forms supramolecular aggregates exhibiting liquid crystallinity in the solution, so that the long axis direction of the supramolecular aggregates is oriented in a flowing direction when flowing after applying shearing stress onto the coating fluid containing this. Examples of such lytropic liquid crystal compounds include azo-base compounds (JP 2006-323377 A), perylene-base compounds (JP 2005-154746 A, JP 08-511109 A), and acenaphtho[1,2-b]quinoxaline-base compounds (JP 2007-512236 A) or the like. Lyotropic liquid crystal compounds based polarizing films are characterized in having a width wider than that of a polyvinyl alcohol film based polarizers and having a thin thickness because of no necessity of stretching.

Generally, lyotropic liquid crystal compounds are oriented by orientation regulating force, such as shearing stress or rubbing treatment and the like. However, conventional polarizing films have raised a problem of low dichroic ratio because of insufficient orientation, that is, irregularity in the direction of lyotropic liquid crystal compounds. Thus, polarizing films that exhibit a high dichroic ratio without such problems have been demanded.

### SUMMARY OF THE INVENTION

It is an object of the present invention to provide a polarizing film having a high dichroic ratio formed by orienting a lyotropic liquid crystal compound.

Inventors of the present invention carried out extensive investigations to improve the dichroic ratio of a polarizing film formed by orienting organic dyes composed of a lyotropic liquid crystal compound. As a result, the inventors have found out that a polarizing film having a high dichroic ratio is obtained by adding a small amount of an acenaphtho[1,2-b]quinoxaline-base compound. “A small amount” herein means that the content of the acenaphtho[1,2-b]quinoxaline-base compound is over 0 weight part and less than 10 weight parts with respect to 100 weight parts of the organic dyes.

The reasons why the dichroic ratio becomes lower in conventional polarizing films are assumed that supramolecular aggregates composed of organic dyes are not perfectly oriented in the same direction, so that the supramolecular aggregates are respectively oriented in a little off direction. According to the assumption of the inventors of the present invention, in the polarizing film of the present invention, a small amount of an acenaphtho[1,2-b]quinoxaline-base compound is added to get into a gap of supramolecular aggregates that are adjacent to the acenaphtho[1,2-b]quinoxaline-base compound. As a result, new electrostatic coupling to couple the supramolecular aggregates to one another is generated, which enables the adjacent supramolecular aggregates to be easily oriented in the same direction, resulting in the polarizing film having a higher dichroic ratio.

In a first preferred embodiment, a polarizing film formed by orienting organic dyes composed of a lyotorpic liquid crystal compound according to the present invention comprises an acenaphtho[1,2-b]quinoxaline-base compound, wherein the content of the acenaphtho[1,2-b]quinoxaline-base compound is less than 10 weight parts with respect to 100 weight parts of the organic dyes.

In a second preferred embodiment of a polarizing film according to the present invention, the acenaphtho[1,2-b]quinoxaline-base compound is a compound represented by the following general formula (I):

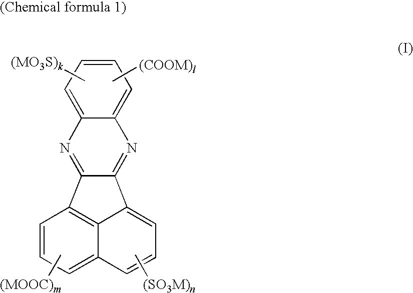

wherein k and l are individually integers from 0 to 4; m and n are individually integers from 0 to 6; however, at least one of k, l, m, and n is not 0; M is a counter ion.

In a third preferred embodiment of a polarizing film according to the present invention, the organic dyes are any one of azo-base compounds, anthraquinone-base compounds, perylene-base compounds, quinophthalone-base compounds, naphthoquinonic-base compounds, and merocyanine-base compounds.

In a fourth preferred embodiment, a polarizing film according to the present invention has a thickness of 0.05 to 5 μm.

### ADVANTAGE OF THE INVENTION

The present invention provides a polarizing film with a high dichroic ratio by adding a small amount of an acenaphtho[1,2-b]quinoxaline-base compound to organic dyes composed of a lyotropic liquid crystal compound.

### BRIEF DESCRIPTION OF THE DRAWINGS

FIG. 1 is a graph of respective dichroic ratio in Examples 1, 2 and Comparative Examples 1, 2.

FIG. 2 is a graph of respective dichroic ratio in Examples 3, 4 and Comparative Examples 3, 4.

### DESCRIPTION OF THE PREFERRED EMBODIMENTS

### Polarizing Film

A polarizing film of the present invention is formed by orienting organic dyes composed of a lyotropic liquid crystal compound and contains an acenaphtho[1,2-b]quinoxaline-base compound. And the content of the acenaphtho[1,2-b]quinoxaline-base compound is less than 10 weight parts with respect to 100 weight parts of the organic dyes. The polarizing film of the present invention has a dichroic ratio higher than conventional polarizing films. The polarizing film of the present invention preferably has a dichroic ratio of 25 or higher.

The polarizing film of the present invention preferably has a thickness of 0.05 to 5 μm, more preferably has a thickness of 0.1 to 3 μm. A polarizing film with a high dichroic ratio can be obtained by making the thickness in the aforementioned range.

The polarizing film of the present invention may contain other liquid crystal compounds or any additives, such as a surfactant, an antioxidant, an antistatic agent and the like except for organic dyes composed of a lyotropic liquid crystal compound and an acenaphtho[1,2-b]quinoxaline-base compound. The content of the additives is preferably less than 10 weight parts with respect to 100 weight parts of the organic dyes.

### (Organic Dyes)

The organic dyes to be used in the present invention are composed of a lyotropic liquid crystal compound. The lyotropic liquid crystal compound is a liquid crystal compound having a property to cause a phase transition of an isotropic phase into a liquid crystal phase according to changes of the temperature and the concentration in a solution state dissolved in a solvent. While the liquid crystal phase to develop is not particularly limited, a preferred examples of this liquid crystal phase is a nematic liquid crystal phase. Such a liquid crystal phase is confirmed and identified by an optical pattern observed using a polarization microscope.

The organic dyes to be used in the present invention are organic compounds, which are mainly composed of an atom, such as carbon, hydrogen, nitrogen, oxygen or the like and absorb light at any one of wavelengths of 380 nm to 780 nm of visible light. The organic dyes may contain a metallic ion as a metal complex.

The lyotropic liquid crystal compounds to be used in the present invention are preferably any one of azo-base compounds, anthraquinone-base compounds, perylene-base compounds, quinophthalone-base compounds, naphthoquinonic-base compounds or merocyanine-base compounds.

The organic dyes to be used in the present invention are preferably perylene-base compounds. The perylene-base compounds are preferably represented by the general formula (II) as below. In the general formula (II), Q₄ represents formula (a) or formula (b). Each of L₁, L₂, L₃, L₄ which are independent of each other, is a hydrogen atom, an alkyl group having 1 to 5 carbon atoms, an alkoxy group having 1 to 5 carbon atoms, a halogen atom, a hydroxyl group or an amino group. O, p, q, r is respectively an integer from 0 to 2, s is an integer from 1 to 4 and satisfies o+p+q+r+s≦8. M is a counter ion. In the formula (a), Q₅ is independently a phenyl group, a phenyl alkyl group or a naphthyl group (These groups may have any substituent groups). L₅ is a hydrogen atom, an alkyl group having 1 to 5 carbon atoms, an alkoxy group having 1 to 5 carbon atoms, a halogen atom, a hydroxyl group or an amino group. t is an integer from 0 to 4.

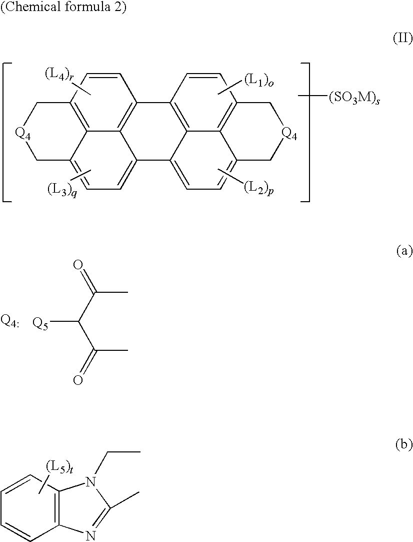

The perylene-base compounds represented by the aforementioned general formula (II) can be obtained by methods, for instance, described in JPO₈-511109 A, JP 2005-154746 A, and JP 2006-098927 A.

The counter ion M in the aforementioned general formula (II) is preferably a hydrogen atom, an alkali metal atom, an alkali earth metal atom, a metal ion or a substituted or unsubstituted ammonium ion. Examples of a metal ion include, for instance, Na⁺ Ni²⁺, Fe³⁺, Cu²⁺, Ag⁺, Zn²⁺, Al³⁺, Pd²⁺, Cd²⁺, Sn²⁺, Co²⁺, Mn²⁺, or Ce³⁺ and the like. For instance, when the polarizing film of the present invention is generated from a water solution, a counter ion M selects a group to improve solubility into water first and then may substitute a water-insoluble group or a group with poor water solubility so as to improve water resistance after forming a film.

The lyotropic liquid crystal compound in the aforementioned general formula (II) is soluble to a hydrophilic solvent, such as water or the like and is highly oriented to form an independently stable liquid crystal phase. As a result, a polarizing film with a high dichroic ratio can be obtained.

(Acenaphtho[1,2-b]quinoxaline-base compound)

The content of the acenaphtho[1,2-b]quinoxaline-base compound contained in the polarizing film to be used in the present invention is less than 10 weight parts with respect to 100 weight parts of the organic dyes. The content of the acenaphtho[1,2-b]quinoxaline-base compound is preferably 1 weight part or more and less than 6 weight parts. The content of the acenaphtho[1,2-b]quinoxaline-base compound is determined as appropriately in the aforementioned range. For instance, when organic dye molecules for forming respective supramolecular aggregates are numerous, that is, when the molecular weight of respective supramolecular aggregates is large, the content of the acenaphtho[1,2-b]quinoxaline-base compound is set somewhat few. On the contrary, when organic dye molecules for forming respective supramolecular aggregates are in small numbers, that is, the molecular weight of respective supramolecular aggregates is small, the content of the acenaphtho[1,2-b]quinoxaline-base compound is set somewhat in generous amount.

Effects that the supramolecular aggregates are oriented in the same direction by entering of the acenaphtho[1,2-b]quinoxaline-base compound into the gap of adjacent supramolecular aggregates are not achieved when the content of the acenaphtho[1,2-b]quinoxaline-base compound is 0 weight part, that is, the acenaphtho[1,2-b]quinoxaline-base compound is not contained. On the other hand, when the content of the acenaphtho[1,2-b]quinoxaline-base compound is 10 weight parts or more, the supramolecular aggregates could be prevented from being oriented due to the excess content.

The acenaphtho[1,2-b]quinoxaline-base compound is preferably represented by the following general formula (I):

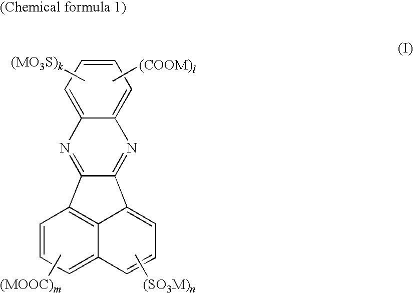

wherein k and l are individually integers from 0 to 4; m and n are individually integers from 0 to 6, however, at least one of k, l, m, and n is not 0; M is a counter ion. Examples of the counter ion M is preferably a hydrogen atom, an alkali metal atom, an alkali earth metal atom, a metal ion or a substituted or unsubstituted ammonium ion. Examples of a metal ion include, for instance, Na⁺ Ni²⁺, Fe³⁺, Cu²⁺, Ag⁺, Zn²⁺, Al³⁺, Pd²⁺, Cd²⁺, Sn²⁺, Co²⁺, Mn²⁺, or Ce³⁺ and the like.

The acenaphtho[1,2-b]quinoxaline-base compound represented by the general formula (I) can be obtained, for instance, by the method described in JP 2007-512236 A (Paragraphs 0054 to 0072).

### (Manufacturing Method)

While it is understood that the method for manufacturing a polarizing film of the present invention is not particularly limited, for instance, the polarizing film of the present invention is manufactured by applying a coating fluid containing organic dyes composed of a lyotropic liquid crystal compound, an acenaphtho[1,2-b]quinoxaline-base compound, and a solvent that dissolves the organic dyes and the acenaphtho[1,2-b]quinoxaline-base compound. While it is to be understood that the solvent is not particularly limited, as the solvent, a hydrophilic solvent is preferably used. The hydrophilic solvent is preferably water, an alcohol, or a cellosolve. The coating fluid preferably has a total solid content concentration of 1% to 50% by weight. Further, the coating fluid preferably exhibits a liquid crystal phase in any of the range having a total solid content concentration of 1% to 50% by weight. While it is to be understood that the substrate on which the coating fluid is applied is not particularly limited, a glass plate or a resin film is used. An alkali-free glass plate which is used for liquid cells is preferable as a glass plate. Examples of materials of the resin film include stylene resin, (meta) acrylic resin, polyester resin, polyolefin resin, norbornene resin, polyimide resin, cellulose resin, polyvinyl alcohol resin, polycarbonate resin or the like. The application method of the coating fluid is not particularly limited and application methods using any coaters, such as a slide coater, a slot die coater, a bar coater, a rod coater, a curtain coater, and a spray coater or the like may be used. While the drying method for the coating fluid is not particularly limited, any drying methods, such as natural drying, reduced-pressure drying, drying by heating, and drying by heating under reduced pressure or the like may be used.

### (Application of Polarizing Film)

The polarizing film of the present invention is applied to any optical usages. Particularly, the polarizing film is preferably applied to liquid crystal display apparatuses, such as office automation appliances, such as personal computer monitors, laptop computers, copy machines or the like, portable devices, such as mobile phones, watches, digital cameras, Personal Digital Assistance (PDA), portable game devices or the like, home appliances, such as video cameras, television units, and microwave oven or the like, car appliances, such as rear-view mirrors, monitors for car navigation system, and car audio videos or the like, displays, such as monitors for information for stores, and security gizmos, such as supervisory monitors, care giving monitors, and monitors for medical purposes or the like.

### EXAMPLES

The present invention will be more clearly understood by referring to the Examples below. However, the Examples should not be construed to limit the invention in any way.

### Synthesis Example 1

### Synthesis of acenaphtho[1,2-b]quinoxaline-2-sodium sulfonate

To a reaction container with an agitator, 12.5 L of glacial acetic acid, 275 g of o-phenylenediamine, and 490 g of acenaphthenequinone were added to be mixed, and then the mixture was allowed to react by stirring for 3 hours under a nitrogen atmosphere at room temperature (23° C.) as indicated in the reaction path mentioned below. Subsequently, precipitates in the reaction container were filtered to obtain a crude product containing acenaphtho[1,2-b]quinoxaline. This crude product was purified by recrystallization with heated glacial acetic acid to isolate the acenaphtho[1,2-b]quinoxaline compound.

300 g of acenaphtho[1,2-b]quinoxaline and 2.1 L of 30% fuming sulfonic acid were put in the reaction container to be mixed and the mixture was allowed to react by stirring for 48 hours at room temperature (23° C.). Subsequently, precipitates in the reaction container were filtered to obtain a crude product containing acenaphtho[1,2-b]quinoxaline-2-sulfonic acid. This crude product was dissolved in ion-exchange water and a sodium hydroxide solution was added to be neutralized. The obtained solution was purified by removing residual sulfuric acid using a high-pressure reverse osmosis membrane element tester with a reverse osmosis membrane filter (manufactured by Nitto Denko Corporation; product name: NTR-7430) to obtain acenaphtho[1,2-b]quinoxaline-2-sodium sulfonate.

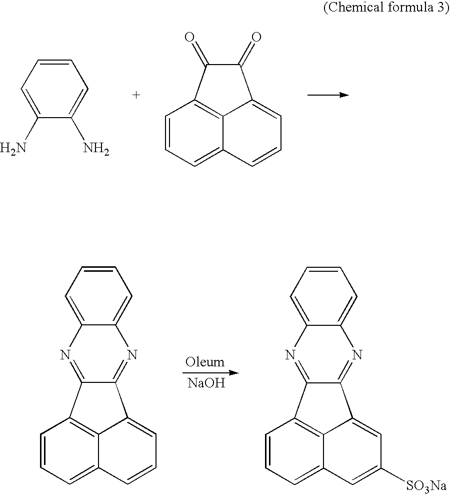

### Synthesis Example 2

### Synthesis of acenaphtho[1,2-b]quinoxaline-9-carboxylic sodium

To a reaction container with an agitator, 500 ml of dimethylformamide, 8.4 g of 3,4-diamino benzoic acid, and 10 g of acenaphthenequinone were added to be mixed, and then the mixture was allowed to react by stirring for 21 hours under a nitrogen atmosphere at room temperature (23° C.) in the reaction path mentioned below. Subsequently, precipitates in the reaction container were filtered to obtain a crude product containing acenaphtho[1,2-b]quinoxaline-9-carboxylic acid. This crude product was purified by washing with dimethylformamide, water and acetone to isolate the acenaphtho[1,2-b]quinoxaline-9-carboxylic acid. This was dissolved in ion-exchange water and a sodium hydroxide solution was added to be neutralized to obtain acenaphtho[1,2-b]quinoxaline-9-carboxylic sodium.

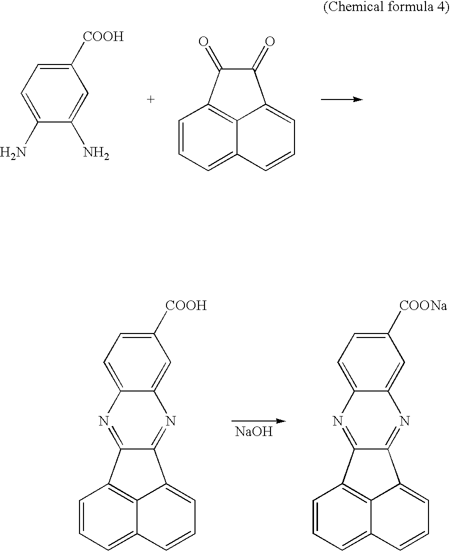

### Example 1

100 weight parts of a solution A (manufactured by Optiva Inc., product name: NO15) containing an organic dye composed of a lyotropic liquid crystal compound and 1.6 weight parts of a solution B containing acenaphtho[1,2-b]quinoxaline-2-sodium sulfonate were mixed to prepare a coating fluid A exhibiting a nematic liquid crystal phase by heating at room temperature (23° C.). This coating fluid A was applied onto a surface of a glass plate (manufactured by Matsunami glass Ind. Ltd., product name: “MATSUNAMI MICRO SLIDE GLASS”) in one direction while applying shearing force in a temperature-controlled room at 23° C. with a bar coater (manufactured by BUSCHMAN Inc., product name: “Mayer rot HS1.5”) and then the lyotropic liquid crystal compound in the coating fluid A was oriented to prepare a polarizing film having a thickness of 0.42 μm by natural drying.

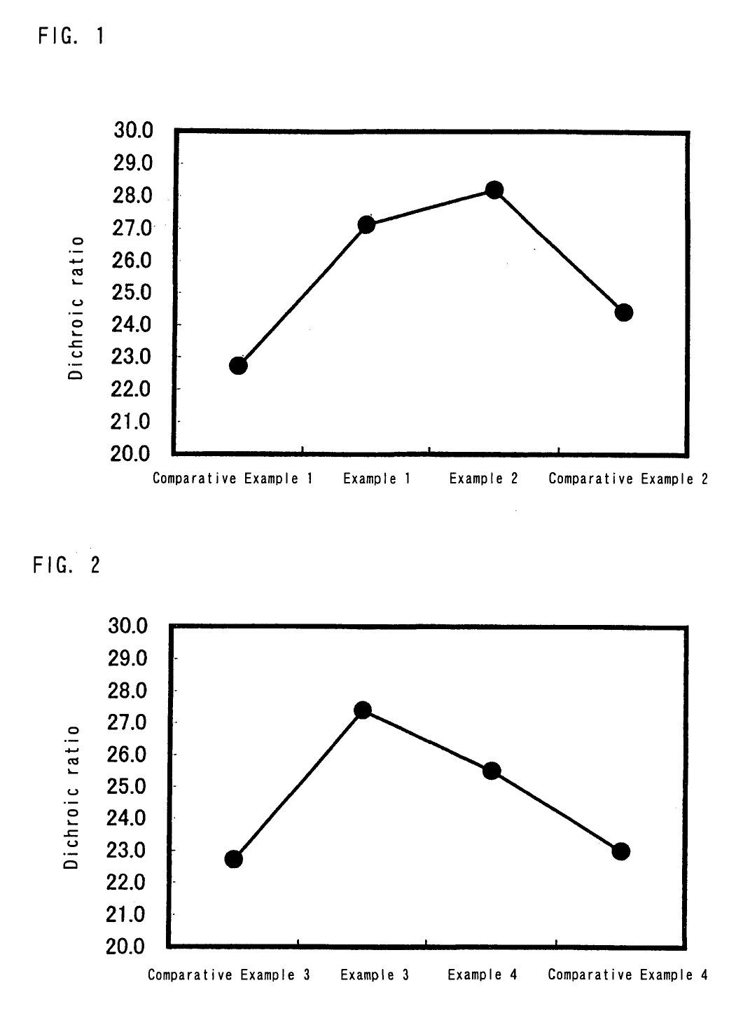

The concentration of the organic dye in the aforementioned solution A was 12.9 weight % and the concentration of acenaphtho[1,2-b]quinoxaline-2-sodium sulfonate was 8 weight %. And the content of acenaphtho[1,2-b]quinoxaline-2-sodium sulfonate in the aforementioned polarizing film was 1 weight part with respect to 100 weight parts of the organic dye. As shown in Table 1 and FIG. 1, the dichroic ratio of this polarizing film was 27.1.

### Example 2

A polarizing film with a thickness of 0.48 μm was prepared in the same manner as Example 1 except that the mixed quantity of the solution B containing acenaphtho[1,2-b]quinoxaline-2-sodium sulfonate was 8.0 weight parts. The content of acenaphtho[1,2-b]quinoxaline-2-sodium sulfonate in the aforementioned polarizing film was 5 weight parts with respect to 100 weight parts of the organic dye. As shown in Table 1 and FIG. 1, the dichroic ratio of this polarizing film was 28.2.

### Comparative Example 1

A polarizing film with a thickness of 0.45 μm was prepared in the same manner as Example 1 except for not mixing the solution B containing acenaphtho[1,2-b]quinoxaline-2-sodium sulfonate. Acenaphtho[1,2-b]quinoxaline-2-sodium sulfonate is not contained in the aforementioned polarizing film. As shown in table 1 and FIG. 1, the dichroic ratio of this polarizing film was 22.7.

### Comparative Example 2

A polarizing film with a thickness of 0.41 μm was prepared in the same manner as Example 1 except that the mixed quantity of the solution B containing acenaphtho[1,2-b]quinoxaline-2-sodium sulfonate was 16.0 weight parts. The content of acenaphtho[1,2-b]quinoxaline-2-sodium sulfonate in the aforementioned polarizing film was 10 weight parts with respect to 100 weight parts of the organic dye. As shown in Table 1 and FIG. 1, the dichroic ratio of this polarizing film was 24.4.

TABLE 1

| | Content of acenaphtho[1,2-b]quinoxaline-2- | | |
|---|---|---|---|
| | sodium sulfonate with respect to 100 | | Dichroic |
| | weight parts of organic dye | | ratio |
| Example 1 | 1 | weight part | 27.1 |
| Example 2 | 5 | weight parts | 28.2 |
| Comparative | Nil | | 22.7 |
| Example 1 | | | |
| Comparative | 10 | weight parts | 24.4 |
| Example 2 | | | |

### Example 3

100 weight parts of a solution A (manufactured by Optiva Inc., product name: “NO15”) containing an organic dye composed of a lyotropic liquid crystal compound and 1.6 weight parts of a solution C containing acenaphtho[1,2-b]quinoxaline-9-sodium carboxylate were mixed to prepare a coating fluid B exhibiting a nematic liquid crystal phase by heating at room temperature (23° C.). The coating fluid B was applied onto a surface of a glass plate (manufactured by Matsunami glass Ind. Ltd., product name: “MATSUNAMI MICRO SLIDE GLASS”) in one direction while applying shearing force in a temperature-controlled room at 23° C. with a bar coater (manufactured by BUSCHMAN Inc., product name: “Mayer rot HS1.5”) and then the lyotropic liquid crystal compound in the coating fluid B was oriented to prepare a polarizing film having a thickness of 0.50 μm by natural drying.

The concentration of the organic dye in the aforementioned solution A was 12.9 weight % and the concentration of acenaphtho[1,2-b]quinoxaline-9-sodium carboxylate in the aforementioned solution C was 8 weight %. And the content of acenaphtho[1,2-b]quinoxaline-9-sodium carboxylate in the aforementioned polarizing film was 1 weight part with respect to 100 weight parts of the organic dye. As shown in Table 2 and FIG. 2, the dichroic ratio of this polarizing film was 27.4.

### Example 4

A polarizing film with a thickness of 0.45 μm was prepared in the same manner as Example 3 except that the mixed quantity of the solution C containing acenaphtho[1,2-b]quinoxaline-9-sodium carboxylate was 8.0 weight parts. The content of acenaphtho[1,2-b]quinoxaline-9-sodium carboxylate in the aforementioned polarizing film was 5 weight parts with respect to 100 weight parts of the organic dye. As shown in Table 2 and FIG. 2, the dichroic ratio of this polarizing film was 25.5.

### Comparative Example 3

A polarizing film with a thickness of 0.47 μm was prepared in the same manner as Example 3 except for not mixing the solution C containing acenaphtho[1,2-b]quinoxaline-9-sodium carboxylate. Acenaphtho[1,2-b]quinoxaline-9-sodium carboxylate was not contained in the aforementioned polarizing film. As shown in table 2 and FIG. 2, the dichroic ratio of this polarizing film was 22.7.

### Comparative Example 4

A polarizing film with a thickness of 0.43 μm was prepared in the same manner as Example 3 except that the mixed quantity of the solution C containing acenaphtho[1,2-b]quinoxaline-9-sodium carboxylate was 16 weight parts. The content of acenaphtho[1,2-b]quinoxaline-9-sodium carboxylate in the aforementioned polarizing film was 10 weight parts with respect to 100 weight parts of the organic dye. As shown in table 2 and FIG. 2, the dichroic ratio of this polarizing film was 23.0.

TABLE 2

| | Content of acenaphtho[1,2-b]quinoxaline-2- | | |
|---|---|---|---|
| | sodium carboxylate with respect to 100 | | Dichroic |
| | weight parts of organic dye | | ratio |
| Example 3 | 1 | weight part | 27.4 |
| Example 4 | 5 | weight parts | 25.5 |
| Comparative | Nil | | 22.7 |
| Example 3 | | | |
| Comparative | 10 | weight parts | 23.0 |
| Example 4 | | | |

### (Assessment)

(1) When the coating fluid does not contain acenaphtho[1,2-b]quinoxaline-2-sodium sulfonate or acenaphtho[1,2-b]quinoxaline-9-sodium carboxylate, its dichroic ratio is far lower than 25.

(2) In the case of acenaphtho[1,2-b]quinoxaline-2-sodium sulfonate, its dichroic ratio is the maximum when the content is 5 weight parts and is a little lower, but still over 25 when its content is 1 weight part. When the content is 10 weight parts, the dichroic ratio is lower than 25, but is still higher than when acenaphtho[1,2-b]quinoxaline-2-sodium sulfonate is not contained.

(3) In the case of acenaphtho[1,2-b]quinoxaline-9-sodium carboxylate, its dichroic ratio is the maximum when the content is 1 weight part and is a little lower, but still over 25 when its content is 5 weight parts. When the content is 10 weight parts, the dichroic ratio is lower than 25, but is still higher than when acenaphtho[1,2-b]quinoxaline-9-sodium carboxylate is not contained.

### (Measurement Method)

### (Polarizing Microscope Observation of a Liquid Crystal Phase)

A solution containing an azo-base compound was sandwiched by 2 pieces of glass slides to observe a liquid crystal phase while changing the temperature using a polarizing microscope (manufactured by Olympus, product name: “BX50”).

### (Measurement Method of Thickness of a Polarizing Film)

A portion of a polarizing film was released to obtain the thickness of the polarizing film by measuring the level difference using a three-dimensional measurement system of the shape of a non-contact surface (manufactured by Ryoka systems, Inc., product name: “MM5200”).

### (Measurement Method of Dichroic Ratio)

Measuring light of linear polarization at a wavelength of 600 nm was allowed to enter using a spectrophotometer with Glan-Thompson polarizer (produced by JASCO Corporation, product name: U-4100) to obtain transmittance k₁ of linear polarizer in a maximum transmittance direction and transmittance k₂ of linear polarizer in a direction that is perpendicular to the maximum transmittance direction by the calculation of the following equations:

Equation: Dichroic ratio=log(1/k₂)/log(1/k₁)

There has thus been shown and described a novel polarizing film, which fulfills all the objects and advantages sought therefor. Many changes, modifications, variations, combinations and other uses and applications of the subject invention will, however, become apparent to those skilled in the art after considering this specification and the accompanying drawings which disclose the preferred embodiments thereof. All such changes, modifications, variations and other uses and applications which do not depart from the spirit or scope of the invention are deemed to be covered by the invention, which is to be limited only by the claims which follow.

1. A polarizing film formed by orienting organic dyes composed of a lyotropic liquid crystal compound, comprising an acenaphtho[1,2-b]quinoxaline-base compound, wherein the content of the acenaphtho[1,2-b]quinoxaline-base compound is less than 10 weight parts with respect to 100 weight parts of the organic dyes.

2. The polarizing film according to claim 1, wherein the acenaphtho[1,2-b]quinoxaline-base compound is a compound represented by the following general formula (I): 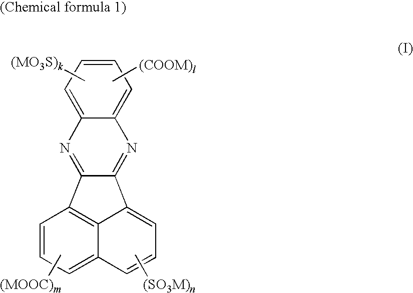
wherein k and l are individually integers from 0 to 4; m and n which are individually integers from 0 to 6; however, at least one of k, l, m, and n is not 0; and M is a counter ion.

3. The polarizing film according to claim 1, wherein the organic dyes are any one of azo-base compounds, anthraquinone-base compounds, perylene-base compounds, quinophthalone-base compounds, naphthoquinonic-base compounds, and merocyanine-base compounds.

4. The polarizing film according to claim 1, wherein the polarizing film has a thickness of 0.5 to 5 μm.

5. The polarizing film according to claim 2, wherein the organic dyes are any one of azo-base compounds, anthraquinone-base compounds, perylene-base compounds, quinophthalone-base compounds, naphthoquinonic-base compounds, and merocyanine-base compounds.

6. The polarizing film according to claim 2, wherein the polarizing film has a thickness of 0.5 to 5 μm.

7. The polarizing film according to claim 3, wherein the polarizing film has a thickness of 0.5 to 5 μm.

8. The polarizing film according to claim 5, wherein the polarizing film has a thickness of 0.5 to 5 μm.
